(19) United States
(12) Patent Application Publication
(10) Pub. No.: US 2004/0201125 A1
(43) Pub. Date: Oct. 14, 2004

(54) Method of forming high-loft spunbond non-woven webs and product formed thereby

(75) Inventors: Martin A. Allen, Dawsonville, GA (US); Patrick L. Crane, Dawsonville, GA (US)

Correspondence Address: WOOD, HERRON & EVANS, LLP (NORDSON), 2700 CAREW TOWER, 441 VINE STREET, CINCINNATI, OH, 45202, US

(73) Assignee: Nordson Corporation, Westlake, OH

(21) Appl. No.: 10/413,130

(22) Filed: Apr. 14, 2003

(51) Int. Cl. D04H 3/16; B32B 5/26; D04H 3/00

(52) U.S. Cl. 264/172.11; 442/352; 442/361; 442/362; 442/364; 442/382; 442/401

(57) ABSTRACT

A method of forming a plurality of substantially-continuous and uninterrupted multi-component filaments for use as a high-loft non-woven web. The multi-component filaments include at least two polymers of different melt flow rates, which imparts latent crimp in each filament. After collection, the latent crimp of the filaments is activated either thermally or by applying tension to the non-woven web.

### FIELD OF THE INVENTION

The present invention relates generally to melt-spinning methods and products, and more particularly to methods of forming high-loft non-woven webs from multi-component filaments and high-loft non-woven webs formed by such methods.

### BACKGROUND OF THE INVENTION

Melt spinning technologies are routinely employed to fabricate non-woven webs and multilayer laminates or composites, which are manufactured into various consumer and industrial products, such as components of single-use or short-life hygienic articles, disposable protective apparel, fluid filtration media, and durables including bedding and carpeting. Melt spinning technologies, including spunbonding processes and meltblowing processes, form non-woven webs and composites from one or more layers of intertwined filaments or fibers, which are composed of one or more thermoplastic polymers.

Certain non-woven webs and composites are formed by a melt-spinning process known as spunbonding, which involves melt spinning of a thermoplastic polymer. The spunbonding process generally involves extruding fine diameter, semi-solid fibers or filaments of one or more thermoplastic polymers from multiple rows of orifices in a spinneret of a melt spinning apparatus. A voluminous flow of relatively cool process air may be directed at the stream of extruded filaments to quench the molten thermoplastic polymer. A high-velocity flow of process air is then used to attenuate or draw the filaments to a specified diameter and to orient them on a molecular scale. The attenuated filaments are propelled in a filament/air mixture toward a forming zone to form a non-woven web or a layer of a laminate on a moving collector.

Non-woven webs formed by conventional spunbonding techniques lack sufficient loft for use in certain consumer and industrial products. The loft may be improved by forming the non-woven web by a conventional manufacturing sequence involving an extrusion process and a crimping process followed by a chopping operation to produce discontinuous filaments. The chopping operation increases the loft of the filaments. The discontinuous filaments are then carded and bonded with a chemical agent or a heat agent. With reference to FIG. 1, the fiber matrix of a conventional improved loft non-woven web 44 includes chopped, randomized fibers 46 arranged with an overlapping distribution.

Fibers treated by such chopping operations are used in various consumer and industrial products that demand additional loft. For example, fluid acquisition and transfer layers in absorbent hygienic articles function more effectively if the loft is enhanced. However, the need to chop the filaments is a complicated process that adds additional processing steps.

The spunbonded filaments may be formed from two or more thermoplastic polymers arranged in distinct regions across the cross-section of a multi-component filament. Multi-component spunbond filaments are extruded using flow passageways in a spinneret arranged to create flow paths for directing the individual polymers separately through the spinneret. Most frequently, multi-component filaments are extruded using two different polymers and, therefore, are more specifically referred to as bicomponent filaments. Crimp may be imparted to these filaments by attenuating with heated air. However, the increase in the loft provided by the attenuation alone may be insufficient.

It is desirable to provide a spunbonding method for forming a high-loft non-woven web and a high-loft spunbonded non-woven web formed by these spunbonding methods.

### SUMMARY

The invention provides a method of making a high-loft spunbond non-woven web and a high-loft non-woven web made by that method. The method includes forming a plurality of substantially continuous and uninterrupted multi-component filaments from at least a first polymer having a first melt flow rate and a second polymer having a second melt flow rate different from the first melt flow rate of the first polymer. The filaments may be formed by any conventional spinneret or by melting each polymer component and combining. Each of the filaments has distinct first and second regions comprising the first polymer and the second polymer, respectively. The multi-component filaments posses latent crimp due to the difference in melt flow rate, which are collected to form a non-woven web. The latent crimp is activated after collection by an activation process, such as heating or applying tension.

The high-loft spunbond non-woven webs of the invention may be utilized for forming various different components. Such high-loft spunbond non-woven webs may be used as layers in hygienic materials. As another more specific example, the high-loft spunbond non-woven webs of the invention may be used to form a fluid acquisition and transfer layer for any absorbent hygienic article that is positioned between an absorbent material and a liquid-permeable top sheet. The fluid acquisition and transfer layer possesses an open porous structure that permits rapid penetration and spread of liquid originating from the hygienic article wearer which can penetrate rapidly and spread out for absorption by the absorbent material of the hygienic article. After absorption, the fluid acquisition and transfer layer separates or isolates the top sheet of the hygienic article and, therefore, the article wearer's skin is not rewetted from the fluid captured in the absorbent material. Although the invention is described in the context of fluid acquisition and transfer layers, the invention is not so limited to that specific use.

The crimped filaments of the invention improve transfer layer performance and reduce the cost of forming a non-woven web with increased loft because the extruded filaments of the non-woven web do not have to undergo a chopping operation that produces discontinuous filaments. In addition, the basis weight requirement for fluid acquisition and transfer layers in absorbent articles may be reduced due to the improved physical properties.

The crimped, substantially continuous and uninterrupted multi-component filaments of the invention may find other applications in which high loft is a desired property of the non-woven web. In absorbent hygienic articles, a non-woven web of the crimped filaments of the invention may be used as one layer of a backsheet for providing a high-placement-error landing zone for a hook-type material of a hook-and-loop fastener or as a loop-type material operating as a landing zone for the hook-type material. In applications other than for hygienic articles, the crimped filaments of the invention may be used as high loft stuffing material in comforters and mattress ticking and as insulation in jackets or insulative fill. Moreover, the crimped filaments of the invention may be used in air filtration products to provide a tortuous air path for filtering particles out of an air stream.

These and other objects and advantages of the present invention shall become more apparent from the accompanying drawings and description thereof.

### BRIEF DESCRIPTION OF THE FIGURES

The accompanying drawings, which are incorporated in and constitute a part of this specification, illustrate embodiments of the invention and, together with a general description of the invention given above, and the detailed description given below, serve to explain the principles of the invention.

FIG. 1 is a diagrammatic view of a non-woven web of crimped fibers as formed in the prior art;

FIG. 2 is a diagrammatic view of a non-woven web of multi-component filaments in accordance with the principles of the invention;

FIG. 3 is a perspective view of a hygienic article incorporating the non-woven web of FIG. 2; and

FIG. 4 is a diagrammatic view of a spunbonding system capable of producing the non-woven web of FIG. 2.

### DETAILED DESCRIPTION OF THE INVENTION

The invention is directed to multi-component filaments and incorporation of those filaments into various components of a hygienic article. With reference to FIG. 3, a disposable hygienic article 10 generally includes a top sheet 12, a back sheet 14, and a fluid storage layer 16 positioned between the top sheet 12 and the back sheet 14. The top sheet 12 transfers aqueous body fluids, such as urine, to the fluid storage layer 16. Hygienic article 10 includes a fluid acquisition and transfer layer 15 between the fluid storage layer 16 and top sheet 12 that allows full utilization of the fluid capacity of the underlying fluid storage layer 16. Fluid acquisition and transfer layer 15 is positioned in the hygienic article between the top sheet 12 and the fluid storage layer 16. Fluid acquisition and transfer layer 15 distributes the aqueous body fluids transferred from top sheet 12 in the x-y dimension. As used herein, the term “X-Y dimension” refers to a plane orthogonal to a Z-dimension or thickness of the non-woven web forming layer 15. The X and Y dimensions usually correspond to the length and width, respectively, of the non-woven web forming layer 15.

The fluid storage layer 16 includes an absorbent material capable of absorbing large quantities of aqueous body fluids and retaining the absorbed fluids under moderate applied pressures. The top sheet 12 is fluid pervious so that aqueous body fluids may readily penetrate through its thickness to the fluid storage layer 16. The back sheet 14 prevents aqueous body fluids absorbed and contained in the fluid storage layer 16 from wetting articles present in the surrounding environment, such as pants, pajamas and undergarments.

The hygienic article 10 includes a pair of closure elements each consisting collectively of a loop-type fastener 18 attached to the back sheet 14 and a hook-type fastener 20 attached to a corresponding attachment tab 19 extending away from the back sheet 14. The loop-type fastener 18 is formed of a loop-type material that includes a plurality of loop members extending outwardly from a backing structure. The hook-type fastener 20 is formed of a hook-type material having a plurality of hook members extending outwardly from a backing structure. The loop-type fastener 18 operates as a landing member or zone and the hook-type fastener 20 operates as an attachment member or zone that is releasably anchorable or attachable to the loop-type member 18. The invention contemplates that various components of the hygienic article 10, such as a layer of the back sheet 14, the fluid acquisition and transfer layer 15, and/or the loop-fastener 18, may be formed from a non-woven web constituted by the substantially continuous and uninterrupted multi-component filaments of the invention.

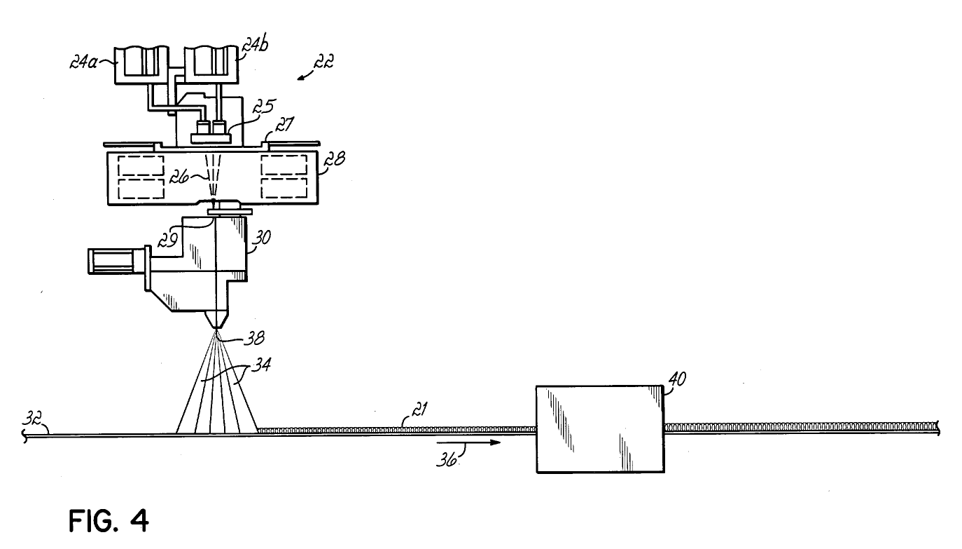

With reference to FIG. 4, a melt spinning apparatus 22 includes a spinneret 25 capable of producing substantially continuous and uninterrupted filaments 26 having at least two distinct polymer regions. Spinnerets 25 capable of extruding filaments 26 are described, for example, in U.S. Pat. No. 6,478,563, co-pending U.S. application Ser. No. 09/702,387 entitled “Apparatus for Meltblowing Multi-Component Liquid Filaments” and filed Oct. 31, 2000, co-pending U.S. application Ser. No. 09/802,646 entitled “Apparatus and Method for Extruding Single-Component Liquid Strands Into Multi-Component Filaments” and filed Mar. 9, 2001, and co-pending U.S. application Ser. No. 09/802,651 entitled “Apparatus for Extruding Multi-Component Liquid Filaments” and filed Mar. 9, 2001. The disclosure of each of these documents is hereby incorporated by reference herein in its entirety.

According to the principles of the invention, the multi-component filaments 26 are prepared from two or more polymers in which the melt flow rate for at least two of the polymers differs by more than 100 grams per 10 minutes (g/10 min), where the melt flow rate is evaluated at a test temperature of 275° C. Typically, the melt flow rate of one constituent polymer ranges from about 10 g/10 min to about 50 g/10 min and the melt flow rate of the other constituent polymer ranges from about 110 g/10 min to about 2,000 g/10 min, wherein the melt flow rates are also evaluated at 275° C. In certain more specific embodiments, the melt flow rate for one polymer ranges from about 10 g/10 min to about 50 g/10 min and the melt flow rate for the other polymer ranges from about 400 g/10 min to about 2,000 g/10 min. Generally, melt flow rate (mfr) is a measure of the rate of extrusion of thermoplastics through an orifice and may be measured as prescribed by ASTM D1238 or ISO 1133.

Each of the substantially continuous and uninterrupted multi-component filaments 26 is arranged as at least two distinct polymer regions. Suitable arrangements include, but are not limited to, sheath/core bicomponent arrangements in which one polymer forms a sheath concentric with a core formed from the other polymer, eccentric sheath/core bicomponent arrangements in which one polymer forms a sheath about a core formed from the other polymer in which the core is offset from the center of the sheath, side-by-side bicomponent arrangements in which the two polymers are arranged side-by-side, multi-lobal bicomponent arrangements, which may be symmetrical or asymmetrical, and island-in-the-sea arrangements. The filaments 26 may have a round, oval, trilobal, triangular, dog-boned, flat or hollow shape.

The polymer or polymers used to fabricate the multi-component filaments 26 may be any of the commercially available spunbond grades of a wide range of thermoplastic polymeric materials including without limitation polyolefins, polyamides, polyesters, polyamides, polyvinyl acetate, polyvinyl chloride, polyvinyl alcohol, cellulose acetate, and the like. The invention contemplates that at least two of the polymers constituting the filaments 26 may be identical thermoplastic materials characterized by different melt flow rates, or may be different thermoplastic materials characterized by different melt flow rates. For example, the individual polymers constituting the filaments 26 may be selected from two polypropylene components of differing melt flow rates. An exemplary family of suitable homopolymer polypropylenes is commercially available from ExxonMobile Chemical includes PP 2252 (4 mfr), Achieve 3854 (24 mfr), Achieve 3825 (32 mfr), PP 3235E1 (33 mfr), PP 3155 (36 mfr), PP 3505GE1 (400 mfr), PP 3546G (1200 mfr) and PP 3746G (1500 mfr) as family members. In one specific embodiment of the invention, the multi-component filaments 26 are halves of a round, side-by-side bicomponent arrangement in which one polymer region is a 33 mfr polypropylene and the other polymer region is an 1200 mfr polypropylene.

The spinneret 25 receives streams of molten polymer from at least two melters 24a, 24b and combines the polymers to form a curtain of the thermoplastic filaments 26 that generally spans the width of a collector 32, such as a table or belt. The airborne curtain of filaments 26 passes through a monomer exhaust system 27 that evacuates any residual monomer gas from the extrusion process. The airborne curtain of filaments 26 next traverses a quenching system 28 that directs a flow of cool process air onto the curtain of filaments 26 for quenching the filaments 26 and initiating the solidification process.

With continued reference to FIG. 4, the airborne curtain of filaments 26 from quenching system 28 is directed by suction into an inlet 29 of a filament drawing device 30. The filament drawing device 30 envelops the filaments 26 with a tangential high velocity flow of process air that applies a biasing or tensile force in a direction substantially parallel to the length of the filaments 26. Because the filaments 26 are extensible, the high velocity flow of process air in the filament drawing device 30 attenuates and molecularly orients the filaments 26 to form attenuated filaments 34. The attenuated filaments 34 are entrained in the high velocity process air when discharged from an outlet 38 of the filament drawing device 30 toward the collector 32. The spinning speed in the filament drawing device 30 is selected such that the crimp of filaments 34 is not significantly induced during the attenuation process. Instead, the attenuated filaments 34 possess latent crimp activated by subsequent processing.

The attenuated filaments 34 are deposited or laid down on the collector 32 in a random manner to form a non-woven web 21. The non-woven web 21 is conveyed on collector 32 in a machine direction 36 to a treatment device 40. Processing the non-woven web 21 in the post-collection treatment device 40 activates the latent crimp of filaments 34. Several different specific activation processes may be used for activating the latent crimp to produce the high-loft spunbond non-woven web 21 of the invention.

In one activation process and with continued reference to FIG. 4, treatment device 40 is a heated enclosure that exposes web 21 to a heated environment of a temperature greater than about 100° F. The elevated temperature is effective for activating the latent crimp of filaments 34. In particular, heating the filaments 34 to such temperatures for a sufficient time causes the length of one of the polymer regions to shrink to a greater extent than the other of the polymer regions.

Another treatment device 40 suitable for activating the latent crimp exposes the non-woven web 21 of multi-component filaments 34 to a plurality of water streams from an aqua jet, which imparts stretching or tensioning forces into the non-woven web 21. The aqua jet includes a nozzle having multiple water-emitting orifices, typically having a density of about 30 to 50 orifices per inch, each emitting a high pressure stream or jet of water in the range of about 500 psi to about 1500 psi that penetrates through the non-woven web 21. The high speed of the water mechanically entangles and places significant stress and strain on the filaments 34, which activates the latent crimp. Suitable aqua jets are commercially available from Fleissner GmbH & Co. (Egelsbach, Germany).

With continued reference to FIG. 4, another treatment device 40 for activating the latent crimp is a tenter frame, which is a machine that dries non-woven web 21 while stretched in a cross-machine direction, generally perpendicular to machine direction 36 (FIG. 4), to a specified width under tension. The tenter frame consists of a heated chamber and a conveyor belt passing through the heated chamber. The conveyor belt has a clamping structure on each of its side edges extending parallel to the machine direction 36 in which the non-woven web 21 carried by the conveyor 32 is moving. The clamping structures diverge outwardly at an angle, for example 15°, relative to each other in the machine direction 36. The non-woven web 21 is transferred from the conveyor 32 to the conveyor belt and grasped by the clamping structure. The non-woven web 21 is stretched or widened by the movement through the tenter frame due to the outward divergence of the clamping structure. The non-woven web 21 is released from the tenter frame after stretching.

The tenter frame may, in the alternative, have a spaced apart pair of endless chains on horizontal tracks rather than a conveyor belt. The non-woven web 21 is held firmly at the edges by pins or clips on the two chains that diverge as they advance through the heated chamber, adjusting the non-woven web 21 to the desired width. The outward divergence stretches or tensions the constituent filaments 34 of the non-woven web 21 primarily in the cross-machine direction, which activates the latent crimp.

Yet another treatment device 40 capable of activating the latent crimp of filaments 34 consists of two sets of nip rollers that are spaced apart in the machine direction 46, in which the non-woven web 21 is transported through the nip rollers. The angular velocity of the two sets of nip rollers differs so that the trailing set of nip rollers rotates faster than the leading set of nip rollers. This difference in angular velocity applies a continuous stretch or tension in the machine direction 36 to the filaments 34. The applied tension activates the latent crimp of the filaments 34 for increasing the loft of the non-woven web 21.

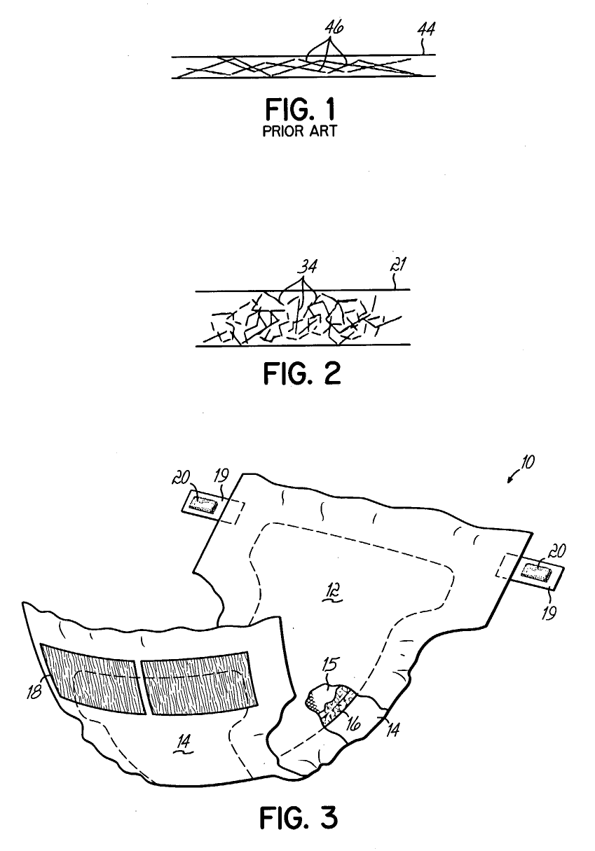

Regardless of the specific type of treatment device 40 relied upon for activating the latent crimp, the multi-component filaments 34 comprising the non-woven web 21 are bulked up by the activated crimp to enhance the loft. With reference to FIG. 2, the non-woven web 21 constituted by the attenuated multi-component filaments 34 of the invention has a greater loft, a reduced density, an improved softness and an increased resiliency when compared with a non-woven web 44 of conventional filaments 46 (FIG. 1). In particular, each of the multi-component filaments 34 crimps in a zig-zag pattern that provides an improved loft, as compared with the loft characterizing non-woven webs 44 formed from conventional chopped discontinuous filaments 46.

Fluid acquisition and transfer layers, such as fluid acquisition and transfer layer 15 of FIG. 3, formed from the high-loft spunbond non-woven webs of the invention have an improved fluid transfer in the x-y direction between the top sheet and the fluid storage layer. Fluid acquisition and transfer layers formed from non-woven webs of the multi-component filaments of the invention also enhance the acquisition rate of an associated absorbent material of the hygienic article because the web porosity (i.e., the ratio of filled to open space) is increased over conventional webs for increasing the liquid transfer rate through the web. The high-loft of the fluid acquisition and transfer layer operates to increase the separation between the article wearer's skin and the fluid storage layer.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicants' general inventive concept. The scope of the invention itself should only be defined by the appended claims, wherein

We claim:

1. A method of making a high-loft spunbond non-woven web comprising:
melting a first polymer having a first melt flow rate;
melting a second polymer having a second melt flow rate different from the first melt flow rate of the first polymer;
combining the first and second polymers to form a plurality of substantially continuous and uninterrupted multi-component filaments having latent crimp, each of the filaments having distinct first and second regions comprising the first polymer and the second polymer respectively;
collecting the plurality of substantially continuous and uninterrupted multi-component filaments to form a non-woven web; and
activating the latent crimp after collection.

2. The method of claim 1 wherein activating the latent crimp further comprises:
applying tension to the non-woven web in an amount effective to cause shrinkage of the second region.

3. The method of claim 2 further comprising:
applying tension using a device selected from the group consisting of a tenter frame, an aqua jet, and two sets of nip rollers spaced along a machine direction and operating at different angular velocities.

4. The method of claim 1 wherein activating the latent crimp further comprises:
heating the non-woven web to a temperature greater than about 100° F.

5. The method of claim 1 wherein the melt flow rates of the two polymers differ by more than about 100 g/10 min.

6. The method of claim 5 wherein the melt flow rate of the first polymer ranges from about 10 g/10 min to about 50 g/10 min and the melt flow rate for the second polymer ranges from about 110 g/10 min to about 2,000 g/10 min.

7. The method of claim 1 wherein the first polymer and the second polymer are the same thermoplastic material.

8. A high-loft spunbond non-woven web formed from a plurality of substantially continuous and uninterrupted multi-component filaments produced by the process comprising the steps of:
melting a first polymer having a first melt flow rate;
melting a second polymer having a second melt flow rate different from the first melt flow rate of the first polymer;
combining the first and second polymers to form a plurality of substantially continuous and uninterrupted multi-component filaments having latent crimp, each of the filaments having distinct first and second regions comprising the first polymer and the second polymer respectively; and
collecting the plurality of substantially continuous and uninterrupted multi-component filaments to form a non-woven web.

9. The non-woven web of claim 8 wherein the multi-component filaments have a sheath/core bicomponent arrangement in which the first region is a sheath formed of the first polymer and the second region is a core formed of the second polymer.

10. The non-woven web of claim 10 wherein the first polymer and the second polymer are different thermoplastic materials.

11. The non-woven web of claim 8 wherein the multi-component filaments are side-by-side bicomponent filaments in which the first polymer region forms a first side and the second polymer region forms a second side.

12. The non-woven web of claim 11 wherein the first polymer and the second polymer are different thermoplastic materials.

13. The non-woven web of claim 8 wherein the non-woven web is used to construct a component of a hygienic selected from the group consisting of a back sheet, a fluid acquisition and transfer layer, and a loop-type material capable of being releasably coupled with a hook-type material of a hook-and-loop fastener.
